(19) United States
(12) Patent Application Publication
(10) Pub. No.: US 2024/0338732 A1
(43) Pub. Date: Oct. 10, 2024

(54) DISPLAY-SYSTEM FOR DISPLAYING PRODUCT OR PRICE INFORMATION

(71) Applicant: VusionGroup GmbH, Fernitz-Mellach (AT)

(72) Inventors: Tarik FILALI ANSARY, Fernitz-Mellach (AT); Philipp JAUCK, Fernitz-Mellach (AT); Francois Xavier GENDRIN, Fernitz-Mellach (AT)

(73) Assignee: VusionGroup GmbH, Fernitz-Mellach (AT)

(21) Appl. No.: 18/575,850

(22) PCT Filed: Jul. 1, 2021
(86) PCT No.: PCT/EP2021/068275

§ 371 Date: Dec. 31, 2023

(51) Int. Cl. G06Q 30/0241; G06V 10/74; G09F 3/20

(52) U.S. Cl. CPC G06Q 30/0248; G06V 10/74; G09F 3/204; G09F 3/208

(57) ABSTRACT

A display-system for displaying product and/or price information that comprises:
at least one electronic display device to display content, which is represented by content data,
a data provision system that is arranged to provide the content data to the at least one electronic display device,
a detection stage that is designed to automatically detect a discrepancy
in the content that is intended to be displayed by the electronic display device, and/or
in the content already displayed by the electronic display device,
   wherein the detection stage is designed to trigger at least one action when a discrepancy is detected.

### TECHNICAL FIELD

The invention relates to a display-system for displaying product or price information.

### BACKGROUND

Electronic display devices, in particular electronic shelf labels and or video shelf rails, are used in display-systems for a variety of tasks at a point of sale and vastly improve the shopping experience. These can be used, for example, to advertise products, to draw customers' attention to a product or to present product and price information in real time. However, the fear that undesired content could be displayed has deterred many business operators from using electronic display devices in the past. Such undesired content can occur, for example, if a typing error occurs when entering the product information so that a different word is created than intended or if the display device or the components of the display-system which control the display device are hacked.

Therefore, the object of the invention is to provide a display-system that overcomes the problems discussed above.

### SUMMARY OF THE INVENTION

This object is achieved by a display-system according to claim 1. Therefore, the subject matter of the invention is a display-system for displaying product and/or price information that comprises at least one electronic display device to display content, which is represented by content data, a data provision system that is arranged to provide the content data to the at least one electronic display device, a detection stage that is designed to automatically detect a discrepancy in the content that is intended to be displayed by the electronic display device, and/or in the content already displayed by the electronic display device, wherein the detection stage is designed to trigger at least one action when a discrepancy is detected.

The measures according to the invention provide the advantage that the display-system automatically checks the content that is intended to be displayed and detects incorrect or unintended input by employees of a supermarket and attempts of unauthorized manipulations by third parties. All these incidents may lead to content that should not be displayed in a public space. Hence, the system blocks the contend which shall be avoided before being displayed. Furthermore, also defective displays can be automatically detected and identified by checking the already displayed content. In summary, the display-system monitors itself against the incidents mentioned and therefore enables the prevention of displaying of incorrect or disturbing content on the electronic display devices in public space (e.g., in the premises of a retailer).

In particular these features form the basis for the automatic prevention of displaying of harmful text or images (e.g., pornography, bad speech, terrorism, etc.).

Further particularly advantageous embodiments and extensions of the invention arise from the dependent claims and the following description.

In general, the display system may comprise a smaller or larger number of electronic display devices. The number of installed display devices may depend on the size of the supermarket and/or the number of products or product groups offered in the supermarket.

Such electronic disapply devices may be realized as so-called electronic shelf labels (ESL) which are installed on shelf rails at positions along the shelf rail in proximity to the product groups or products with which they are logically linked. They typically comprise a low- or close-to-zero-power consuming display (e.g., realizes by electronic paper or electrophoretic technology) to show product and/or price information for said product groups or products. The content that is shown by the display is provided by the content data which are sent to the ESLs either by radio signals or wire-based and typically convey text(s) and/or image(s) which are in turn displayed by the display.

Such electronic display devices may also be realized as so termed video rails, which comprise one or more video screens that are installed on (or along) a shelf rail or form the shelf rail by itself. In contrast to the ESLs the video rails comprise a video display and therefore can display videos and/or virtual electronic shelf labels. The virtual electronic shelf labels may be freely positioned along the display of the video rail and may also overlap the video. Again, said content data are provided to the video rail to convey the video and/or virtual electronic label, which are in turn displayed by the display.

Such electronic display devices may also be realized as smart posters, which allow for a situation specific display of content.

The content data are generated and provided by the data provision system. The data provision system may be realized by a cloud based (software and/or hardware) service or by a local server in the premises of the supermarket, wherein in both cases a software is executed on the respective computer architecture which processes human readably text(s) or picture(s) that is content to be displayed by the respective electronic display device. The processing leads to the content data, which are coded in the appropriate data format and which are supplied to the electronic display devices.

Typically, the data provisioning system is connected to a communication network within the premises of a supermarket, which is designed to deliver the content data either by radio signals or by wires to the respective electronic display device. Such a communication network may comprise radio access points, of which each is designed to perform a radio communication with a group of electronic display devices. Such a communication network may also comprise routers or controllers and the like, to which the electronic display devices are connected, preferably in groups.

The data provision system typically comprises a shop management software that maintains a data base which stores a plan of the entire show, the shelfs, the products on the shelfs and the electronic shelf labels linked to the respective product. Such a data structure is commonly known as planogram. Hence the data provisioning system allows to address each individual electronic display device to display individual content, which was automatically generated or defined by an authorized user of the display system.

The data provisioning system may further comprise one or more computer-based input devices which allow the authorized user of the display system to select or to define the human readably text(s) or picture(s) which is intended to be displayed by one of the electronic display devices or a group of the electronic display devices. Such an input device may be for example, a computer terminal, a personal digital assistant, a mobile phone, a tablet computer etc. Theses input devices execute a user interface software on their computer hardware, which is programmed to allows the user to perfume the appropriate user interaction for the selection or to definition of the human readably text(s) or picture(s) and to interface with the shop management software. The input devices further comprise the hard- and software needed to supply a representation of the human readably text(s) or picture(s) in digital form, e.g., in an intermediate data format or as the content data to the data provisioning system.

A discrepancy can reflect a variety of incidents that would lead to the potential display of undesirable content if no action is taken. As undesirable content can be mentioned in a non-exhaustive way:
Undesirable content may be for example a word that is created by auto correction of text but does not fit to the product which it should describe.
Undesirable content may also be content that is not suitable for minors.
Undesirable content may also be content that could be interpreted in a racist manner or that is of a terrorist nature.

To prevent the display of the undesirable content the detection stage is designed to trigger at least one of following actions:
to send an information about the occurrence of a discrepancy to the data provision system: This gives the data provision system and/or an authorized user (e.g., an operator) of the data provision system feedback about the fact of detection of a discrepancy and allows the data provisioning system to automatically adjust erroneous or critical content or allows the operator to manually adjust such a content.

The incidence causing the detection of the discrepancy may have its reason by the input of an employee of the supermarket who enters new product and price information for the electronic display devices and, for example, keys in “sex” instead “six”.
to send an information about the occurrence of a discrepancy to a communication device: Such a communication device might for example be a computer located in the supermarket back-office or a mobile phone of an employee who is responsible for stocking the shelves. The information about the occurrence of a discrepancy can thus be automatically transmitted to the communication device that can process this information, which enables the person responsible to take appropriate actions. The communication device can be a device that is independent of the data provision system, or it can be a component of the data provision system. In particular, the communication device can also be the input device of the data provision system.
to update the content displayed on the electronic display device: This can help prevent content that could damage the company's reputation from being displayed. For this purpose, for example, if a discrepancy is detected, the screen can switch to an empty image or turn off. However, the electronic display devices can also switch to another image and/or text and display this other image and/or text. This image and/or text can contain, for example, a note that helps employees to find the corresponding electronic display devices among many electronic display devices. The data that present this other image and/or text can be transmitted to the electronic display device for this purpose if a discrepancy is detected. The data that present this other image and/or text can also be stored in advance in the electronic display device. For this purpose, the electronic display device can be designed to display this previously stored image and/or text if it receives an indication of a discrepancy.
to trigger an optical or acoustic alarm: On the one hand, this helps to deter the manipulator in the event of a manipulation attempt which is performed on site. On the other hand, it gives the sales staff an indication that a discrepancy has occurred. The alarm can be visualized on the communication device or the input device respectively. The alarm can be emitted from a central point in the supermarket. The alarm can also be emitted from the electronic display device, which allows rapid localization of the electronic display device concerned.
to document the occurrence of a discrepancy: Thus, the occurrence of a discrepancy can be set in the temporal or spatial context, which in turn enables further improvement on system safety and reliability of the operation of the system.
to update a counter that counts the occurrence of discrepancies. Such a counter can count the occurrence of discrepancies and to store them as an integer value. The result of the counter can also be made depended on the kind of discrepancy that occurred and to reflect the quantity and or the quality of the kind of discrepancy which occurred. This may lead to a score, which may be stored, for the respective discrepancy detected and the score may be used to define the respective action to be taken. The score may be compared with a threshold and an action may only be trigger if the score exceeds the threshold. The result of the counter or the score may also reflect the temporal and spatial context of the occurrence of the discrepancy. For example, a higher score can be awarded if the content contains words that on the one hand can be understood obscenely. On the other hand, a higher score may also be awarded if the combination of certain trigger words (for example “crazy” in combination with “women”) may give the combination a discriminatory character, while the words when taken independent from each other or in another combination (for example “crazy” in combination with “taste”) are unproblematic.

These and further actions may be taken depended on the location in the system where the discrepancy is detected.

As already indicated in the preceding it is of particular advantage that the detection stage is designed to detect the discrepancy in the content by analyzing the content in regard of intended content and/or unintended content. This allows to clearly define which content is acceptable and which content is not acceptable and requires a corresponding action. If for example the content to be analyzed is text, it can be easily distinguished between intendent and unintended content by for example comparing the text or the words of the content with predefined templates of words or combination of words which should or shell be avoided.

Further to this it is of advantage that the detection stage is design to identify a pattern in a text of the content or in an image of the content, which identify pattern allows to differentiate between intended and unintended content. This makes it possible to check the content to identify individual patterns (components or elements) thereof which require particular attention in the detection process to detect discrepancies. Such individual elements in the context of textual or pictorial content may for example be a content that visualizes “s E x”. Such a content can hardly be identified by comparing it with trigger words or the like. In Order to identify such content, it is of advantage that the content undergoes for example an OCR-detection (OCR stands for optical character recognition) to detect harmful speech. On the other hand, also a colometry detection may be used to detect erroneous images.

Further to this it is of advantage that the detection stage is designed to differentiate between intended and unintended content by using a predefined lookup table of text elements or phrases or image-elements. The lookup table may in fact be a database that contains a collection of critical text elements or phrases or image-elements in digital form, which is used in the detection process of the detection stage. This allows in an easy way to predefine the undesired content. It further allows to define different undesired content for different types of businesses. Thus, the flexibility of the application of the invention in different business scenarios is secured.

As already mentioned, it is of advantage that the detection stage is designed to analyze the content in order to detect harmful speech or harmful images and/or erroneous images. The analysis is based either on the alphanumeric characters or the pictorial elements. Character strings or texts are analyzed or otherwise graphic elements are analyzed in order to identify the undesired or unintended content It further allows to define different undesired content for different types of business.

According to one aspect of the invention the data provision system comprises an input device, which is designed to define at least parts of the content to be displayed by the electronic display device, and wherein the input device comprises the detection stage. The display of undesired content can thus be counteracted even before it is displayed on the electronic display devices. In particular, the unintended content can be detected immediately during the input process. Here, the operator of the input device has the possibility to immediately correct his/her input if the system allows this. However, it may also be implemented that after the detection of the discrepancy any further input may be blocked and only re-allowed if an administrator grands permission.

According to a further aspect of the invention the data provision system comprises a server or a cloud, which is designed to deliver the content data to the electronic display device, and wherein the server or the cloud comprises the detection stage. This allows the content to be checked directly before it is transmitted to the electronic display devices. The display of undesired content can thus be counteracted before it is sent to the electronic display devices. If, for example, the content was only manipulated after it was entered via the input device or only after an upload into the server or cloud, this can be recognized, and counteractions can be taken. In this scenario it might be assumed, that the system was hacked by a third party which might automatically lead to a master-alarm.

According to a further aspect of the invention the electronic display device comprises the detection stage. In this way, regardless of where the content data was manipulated or incorrectly created, it can be prevented from being displayed unnoticed by the staff. This measure can be taken independently of other measures for detecting the discrepancy. However, it can also occur in combination with the afore-mentioned measures. In this case it represents the last lifeline if the upstream measures do not detect the discrepancy.

According to a further aspect of the invention the display-system comprises a camera which is designed and arranged to capture the content displayed on the at least one electronic display device and to generate capture data, which represent the captured content. This allows the content actually displayed by the electronic display devices to be grasped. Such a camera may capture a single electronic display device or a number of electronic display devices which are located within the detection area of the camera. Such a camera may for example be installed on the ceiling of supermarket and oriented in such a way that it films the shelfs which are visible for the camera. Such a camera may also be installed directly on the shelf or even on the shelf-rail and films another shelf or shelf-rail positioned on the other side of a shelf aisle.

According to a camera-based embodiment of the invention the camera comprises the detection stage and the detection stage is designed to process the capture data to automatically detect a discrepancy already displayed by the electronic display device. This allows the capture data to be evaluated in the immediate vicinity of the electronic display device where the discrepancy occurs. Hence, it is sufficiency to only identify the camera, which identified the discrepancy in order to identify a group of electronic display devices in which the discrepancy occurs. The basis for such a group-wise identification may be the planogram where all the locations of the electronic display devices together with the camaras and their view-angle may be recorded. To take rapid action (for example the removal of the defect electronic display device from the shelf) it is sufficient to know the location of the camera and its capture-orientation ot view-angle. This allows the stuff to rush to the shelf which is concerned and manually identify the electronic display device which must be removed.

According to a further camera-based embodiment of the invention the data provision system is designed to receive the capture data from the camera and the data provision system comprises the detection stage, which is designed to process the capture data to automatically detect a discrepancy already displayed by the electronic display device. This enables a bundled evaluation of the capture data even received from a large number of camaras by the high performant data provision system. The cameras can therefore be relatively simple and inexpensive. A large number of electronic display devices can thus be checked with relatively few and inexpensive camera-components.

In particular in a camera-based embodiment of the invention it may be of advantage, that the detection stage is arranged to detect the discrepancy by comparing the capture data and the content data. Beside the recognition of potential unintended content also errors in the electronic display device can be recognized which would otherwise remain undetected. Such errors might be in a non-exhaustive list: a crack in the glass/display of the electronic display device, a defective pixel of the electronic display device or simply dirt on the display of the electronic display device.

In general, as a further aspect of the invention the detection stage is designed to select an action based on the number of discrepancies detected. A situation-dependent reaction of the display-system is thus possible. For example, if the number of discrepancies detected over a group of electronic display devices rises above a predefined threshold a major incident may be assumed, for example a major hack on the entire system. Thus, a rapid, massive and global action must be taken, which may be one of the earlier explained actions or a combination of these actions.

Finally, it is to mention that electronic devices mentioned in the description of this patent application may be realized by the aid of well-known discreet and/or integrated electronics. Provided that interfaces are required the person skilled in the art will be able to select and design the appropriate interface-circuitry (transceivers) to enable data and/or signal communication. Programmable devices may comprise a microprocessor and some peripheral electronics. Such programmable devices may also be realized by the aid of a microcontroller or an application specific intergraded circuit (ASIC) and the like. Execution of software routines on such devices provides computer implemented functions that are discussed herein.

These and other aspects of the invention are obtained from the FIGURES discussed below.

### BRIEF DESCRIPTION OF THE FIGURES

The invention is explained again hereafter with reference to the attached FIGURE and based on exemplary embodiments, which nevertheless do not limit the scope of the invention. The FIGURE shows in schematic fashion in:

FIG. 1 an example of the display system.

### DESCRIPTION OF THE EXEMPLARY EMBODIMENTS

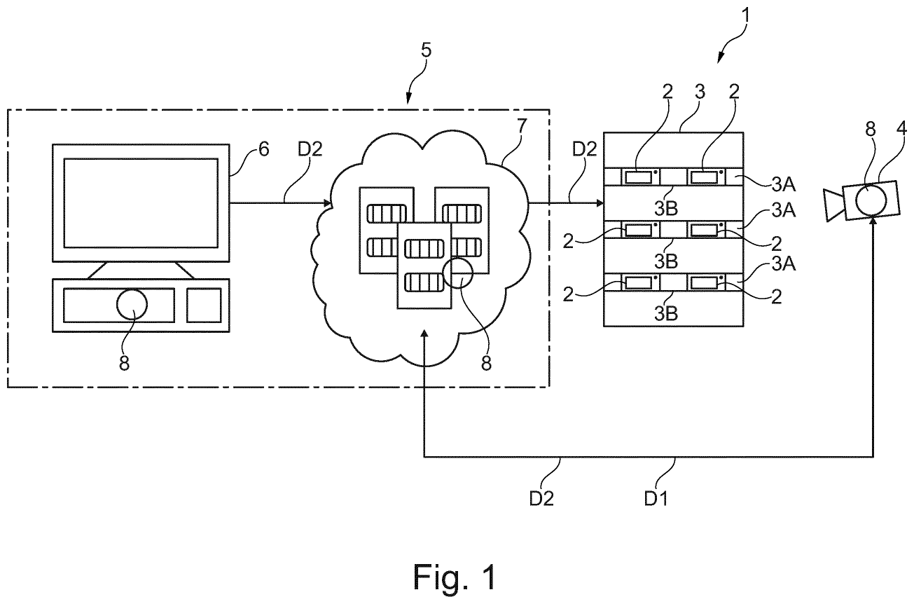

FIG. 1 visualizes the display-system 1 that is installed in a supermarket. As an example of shelves 3 that are set up in the supermarket, only one is shown. The shelf 3 carries six electronic display devices 2, which in the present embodiment are realized as electronic shelf labels and, in the following, indicated as ESLs 2. The ESLs 2 are affixed to shelf rail 3A at positions where products are located on shelf floors 3B (not shown).

The display-system 1 further comprises a camera 4 that captures the shelf 3, the ESLs 2 thereon as well as the content that is displayed on the ESL 2 and generates capture-data D1 which represent the captured scenery. These capture-date D1 may be used for various shop management activities. For the sake of clarity, it is mentioned that also a plurality of cameras 4 may be installed to monitor the plurality of different shelves 3 or groups thereof.

The display-system 1 further comprises a data provision system 5, which forms a subsystem of the display-system 1. The data provision system 5 generates content data D2 which are sent to the individual ESLs 2 and which represent product and/or price information which under normal circumstances is intended content to be displayed by the ESLs 2. Typically, the content data D1 are transmitted via radio network to the ESLs 2, wherein the components of this radio network are not shown in the FIG. 1 because they are basically known to the person skilled in the art.

The intended content is created by the aid of an input device 6, which in the present case is a personal computer that is located in a back-office of the supermarket. An authorized user (for example an employee of the supermarket) defines the intended content for the ESLs 2, the input of the user is received and processed by the input device 6 and forwarded to a cloud-based service 7 where the final content data D1 are created. The cloud-based service 7 is realized by a computer or server farm on which a software is executed, which provides all the features typically needed by the operator of the supermarket to manage the ESLs 2. This may include the mentioned creation of individual content data D2 for the individual ESLs 2 as well the creation and maintenance of a planogram or shop or floor plan in digital form. Also, other functionalities like payment features or logistics of products and ESLs may be included.

The data provision system 5 may also receive and process the capture data D1 from the camera 4 and uses it to identify an out-of-stock situation for products, a misplacement of products or a mismatch of ESLs 2 with products etc.

To avoid the display of an unintended content or to reduce the impact of the display of unintended content by the ESLs 2 the display-system 1 further comprises a detection stage 8 that is designed to automatically detect a discrepancy in the content that is either intended to be displayed by the electronic display device, which means that this content has not yet reached the ESLs 2, or that is already displayed by the electronic display device 2.

The detection stage 8 is realized as a software application or routine, which, dependent on the actual implementation, is executed by the computer of the input device(s) 6, by the computer(s) of the cloud-based service 7 or by the computer of the camera(s) 4 or even by the ESL 2 itself. FIG. 1 shows various locations where the detection stage 8 can be implemented.

If the detection stage 8 is realized at the input device 6, the detection stage 8 can check the input of the user and may detect unintended content directly at the entry point into the data provision system 5. The detection stage 8 can therefor prohibit the further processing and propagation of such unintended content within the data provision system 5 and trigger an alert, for example give immediate feedback to the respective user.

If the detection stage 8 is realized at the cloud-based service 7, the detection stage 8 can check the input of the user received from the input device 6, which at least from a user's standpoint represents content that is intended to be displayed by the ESLs 2, and the capture data received from the camera 4, which represent content already displayed by the ESLs 2.

On the one hand the content received from the input device 6 can be subject to a data manipulation by a third party and therefore deviate from the original content created by the user. This digital manipulation by the third party can be detected by the detection stage 8 and like the above-mentioned scenario the detection stage 8 can prohibit the further processing and propagation of such unintended content within the data provision system 5 and trigger an alert, for example give immediate feedback to the respective user and/or send a detection information to an administrator.

On the other hand, the capture data received from the camera(s) 4 can also be checked for a discrepancy, which may have its origin in a third-party intervention on the content data D2 submitted from the data provision system 5 to the ESLs 2. Again, this digital manipulation by the third party can be detected by the detection stage 8 and different to the above-mentioned scenario the detection stage 8 can now for example initiate the deletion of the content already displayed by the ESLs 2. Again, the detection stage 8 can trigger an alert, for example give immediate feedback to the respective user or send a detection information to an administrator.

Further to this the capture data received from the camera(s) 4 can also be checked for a discrepancy, which may have its origin in an electrical or mechanical failure of the ESLs 2. If under these circumstances the screen of the ESL(s) 2 concerned may be switched off or blanked, may depend on the strength of the discrepancy detected, which is decided by the detection stage 8 that uses a digital image processing. Anyhow, the detection stage 8 can trigger an alert, for example forward a deception information to the respective user or an administrator.

If the detection stage 8 is realized at the camera(s) 4 all detections based on the capture data D1 mentioned in the two preceding paragraphs can be performed directly by the camera(s) 4. In one embodiment the detection process of the detection stage 8 runs autonomously without any information about the original input of the user or the corresponding content data D2. In this embodiment the detection stage 8 can identify such unintended content that is under no circumstances intended to be displayed in a public space or in other words an obviously unintended content. In another embodiment the original input of the user and/or the content data D2 can be supplied to the camera(s) 4 to be considered by the detection process. In this embodiment the detection stage 8 can identify such an unintended content which is not so obvious or in other words “which may be hidden between lines”. Dependent on the type of discrepancy detected, the detection stage 8 can trigger the appropriate alarm.

Furthermore, it is to mention that the detection stage 8 may also be embedded in the ESLs 2, which allows the ESLs 2 to self-monitor or self-check at least the content data D2 received from the data provision system 5.

To be complete it is highlighted that the detection stage 8 does not have to be realized solely at one of the elements mentioned. The detection stage 8 may be implemented concurrently at all these different elements or at a group of such elements in the display system 1. The recognition stages 8 arranged at various elements of the display system can also check their results against one another and derive a consolidated assessment of the checked content. The recognition stages 8 may also be connected to each other in a daisy chain configuration along the elements of the display system 1 and therefore a result of a preceding recognition stage 8 may be considered at the next detection stage 8 downstream in direction towards the ESL 2. All of these measures may enhance the security of the display system 1.

Finally, let it be noted once again that the figures described in detail above only involve exemplary embodiments, which the expert can modify in a wide variety of ways without departing from the area of the invention. For the sake of completeness, let it also be stated that use of the indeterminate article “a” or “an” does not mean that the respective features cannot be present multiple times.

1. A display-system (1) for displaying product and/or price information that comprises:
at least one electronic display device (2) to display content, which is represented by content data (D2),
a data provision system (5) that is arranged to provide the content data (D2) to the at least one electronic display device (2),
a detection stage (8) that is designed to automatically detect a discrepancy
in the content that is intended to be displayed by the electronic display device (2), and/or
in the content already displayed by the electronic display device (2),
wherein the detection stage (8) is designed to trigger at least one action when a discrepancy is detected.

2. The display-system (1) according to claim 1, wherein the action includes at least one of the following:
to send an information about the occurrence of a discrepancy to the data provision system (5),
to send an information about the occurrence of a discrepancy to a communication device,
to update the content displayed on the electronic display device (2),
trigger an optical or acoustic alarm,
to document the occurrence of a discrepancy,
to update a counter that counts the occurrence of discrepancies.

3. The display-system (1) according to claim 1, wherein the detection stage (8) is designed to detect the discrepancy in the content by analyzing the content in regard of intended content and/or unintended content.

4. The display-system (1) according to claim 3, wherein the detection stage (8) is design to identify a pattern in a text of the content or in an image of the content, which identified pattern allows to differentiate between intended and unintended content.

5. The display-system (1) according to claim 4, wherein detection stage (8) is designed to differentiate between intended and unintended content by using a predefined lookup table of text elements or phrases or image-elements.

6. The display-system (1) according to claim 3, wherein the detection stage (8) is designed to analyze the content in order to detect harmful speech or harmful images and/or erroneous images.

7. The display-system (1) according to claim 1, wherein the data provision system (5) comprises an input device (6), which is designed to define at least parts of the content to be displayed by the electronic display device (2), and wherein the input device (6) comprises the detection stage (8).

8. The display-system (1) according to claim 1, wherein the data provision system (5) comprises a server or a cloud (7), which is designed to deliver the content data (D2) to the electronic display device (2), and wherein the server or the cloud (7) comprises the detection stage (8).

9. The display-system (1) according to claim 1, wherein the electronic display device (2) comprises the detection stage (8).

10. The display-system (1) according to claim 1, wherein the display-system (1) comprises a camera (4) which is designed and arranged to capture the content displayed on the at least one electronic display device (2) and to generate capture data (D1), which represent the captured content.

11. The display-system (1) according to claim 10, wherein the camera (4) comprises the detection stage (8) and the detection stage (8) is designed to process the capture data (D1) to automatically detect a discrepancy already displayed by the electronic display device (2).

12. The display-system (1) according to claim 10, wherein the data provision system (5) is designed to receive the capture data (D1) and the data provision system (5) comprises the detection stage (8), which is designed to process the capture data (D1) to automatically detect a discrepancy already displayed by the electronic display device (2).

13. The display-system (1) according to claim 11, wherein the detection stage (8) is arranged to detect the discrepancy by comparing the capture data (D1) and the content data (D2).

14. The display-system (1) according to claim 1, wherein the detection stage (8) is designed to select an action based on the number of discrepancies detected.
